(19) United States
(12) Patent Application Publication
(10) Pub. No.: US 2023/0357939 A1
(43) Pub. Date: Nov. 9, 2023

(54) NANOSTRUCTURE-BASED ATOMIC SCALE ELECTROCHEMICAL REACTION CATALYSIS

(71) Applicant: The Regents of the University of Michigan, Ann Arbor, MI (US)

(72) Inventors: Pengfei Ou, Montreal (CA); Jun Song, Montreal (CA); Zetian Mi, Ann Arbor, MI (US); Baowen Zhou, Ann Arbor, MI (US)

(21) Appl. No.: 18/026,452

(22) PCT Filed: Sep. 15, 2021
(86) PCT No.: PCT/US2021/050444

§ 371 Date: Mar. 15, 2023

Related U.S. Application Data
(60) Provisional application No. 63/078,486, filed on Sep. 15, 2020.

(51) Int. Cl. C25B 11/077; C25B 1/55; C25B 1/04; C25B 9/50; C25B 11/055; C25B 11/087

(52) U.S. Cl. CPC C25B 11/077; C25B 1/55; C25B 1/04; C25B 9/50; C25B 11/055; C25B 11/087

(57) ABSTRACT

An electrode for a reaction in a chemical cell includes a substrate having a surface, an array of nanostructures supported by the substrate and extending outward from the surface of the substrate, each nanostructure of the array of nanostructures having a semiconductor composition, and a catalyst arrangement disposed along each nanostructure of the array of nanostructures, the catalyst arrangement comprising a metal-based catalyst for the reaction in the chemical cell. The semiconductor composition of each nanostructure of the array of nanostructures establishes sites at which the metal-based catalyst is anchored to the nanostructure. The array of nanostructures and the catalyst arrangement are configured such that the metal-based catalyst is distributed along sidewalls of each nanostructure of the array of nanostructures at an atomic scale.

### CROSS-REFERENCE TO RELATED APPLICATION

This application claims the benefit of U.S. provisional application entitled “Nanostructure-Based Atomic Scale Electrochemical Reaction Catalysis,” filed Sep. 15, 2020, and assigned Ser. No. 63/078,486, the entire disclosure of which is hereby expressly incorporated by reference.

### BACKGROUND OF THE DISCLOSURE

### Field of the Disclosure

The disclosure relates generally to photoelectrocatalysis of water splitting and other chemical reactions.

### Brief Description of Related Technology

Photoelectrocatalytic water splitting by utilization of solar energy and electricity presents a carbon-free route for the production of hydrogen, which holds grand promise for challenges faced worldwide today, including, e.g., energy shortage, global warming, and environmental issues. An efficient hydrogen evolution reaction catalyst is at the core of a photoelectrochemical cell for solar-driven water splitting. Up to now, platinum is well known as the state-of-the-art electrocatalyst for the hydrogen evolution reaction. Unfortunately, the high price and low abundance of platinum severely limits its large-scale applications.

Noble-metal-free electrocatalysts of the hydrogen evolution reaction have been explored. A wide variety of earth-abundant materials such as phosphides and chalcogenides have been developed as promising substitutes for platinum arising from their low cost and high activity. However, their overall efficiencies are still far below the demand of commercial applications. Such electrocatalysts have also required acidic media to produce hydrogen with high efficiency.

[FeFe]-hydrogenase, a homogeneous metalloenzyme from green plants, is the most efficient HER biocatalyst, owing to its unique atomic structure, well-defined catalytic centers, and superior metal-utilization efficiency. Inspired by this masterpiece of nature, tremendous efforts have been devoted to exploring an iron-based hydrogenase synthetic material for water splitting towards hydrogen. For example, an assembly of chromophores to a bis(thiolate)-bridged diiron ([2Fe2S]) has been proposed as a catalyst for hydrogen production by using a modular supramolecular approach. A set of water-soluble [FeFe]-hydrogenase synthetic materials have also been developed, and, via integration with CdSe quantum dots, demonstrated superior activity for photocatalytic hydrogen production in water. However, these homogeneous hydrogenase synthetic materials are restricted by a series of shortcomings, including complex fabrication, inherent fragility, and great difficulty in scaling up to industrial applications.

Atomically dispersed metals are emerging as a rising star of heterogeneous catalysts with impressive homogeneous features, such as well-defined catalytic centers, low-coordination environment, and high-efficiency atom utilization. In addition, atomic-level catalysts possess strong metal-support interactions and high surface energy, thus presenting great promise to achieve high performance for various chemical reactions.

Atomically dispersed metals have been explored for water splitting. For example, atomic-scale cobalt supported on nitrogen-doped graphene provided an efficient and inexpensive electrocatalyst for hydrogen generation from water splitting. Catalytical sites were associated with the metal centers coordinated to nitrogen. Similarly, tuned by electrochemical methods, atomically dispersed nickel species were anchored on graphitized carbon for electrocatalytic water splitting towards hydrogen. Despite these steps, the area of atomically dispersed metals in catalyzing hydrogen evolution reaction is still in the infant stage.

### SUMMARY OF THE DISCLOSURE

In accordance with one aspect of the disclosure, an electrode for a reaction in a chemical cell includes a substrate having a surface, an array of nanostructures supported by the substrate and extending outward from the surface of the substrate, each nanostructure of the array of nanostructures having a semiconductor composition, and a catalyst arrangement disposed along each nanostructure of the array of nanostructures, the catalyst arrangement including a metal-based catalyst for the reaction in the chemical cell. The semiconductor composition of each nanostructure of the array of nanostructures establishes sites at which the metal-based catalyst is anchored to the nanostructure. The array of nanostructures and the catalyst arrangement are configured such that the metal-based catalyst is distributed along sidewalls of each nanostructure of the array of nanostructures at an atomic scale.

In accordance with another aspect of the disclosure, a photocathode for a reaction in a photoelectrochemical cell includes a substrate including a light absorbing material, the light absorbing material being configured to generate charge carriers upon solar illumination, an array of nanostructures supported by the substrate and extending outward from the surface of the substrate, each nanostructure of the array of nanostructures having a semiconductor composition, each nanostructure of the array of nanostructures being configured to extract the charge carriers from the substrate, and a catalyst arrangement disposed along each nanostructure of the array of nanostructures, the catalyst arrangement including a metal-based catalyst for the reaction in the photoelectrochemical cell. The array of nanostructures and the catalyst arrangement are configured such that the metal-based catalyst is distributed along sidewalls of each nanostructure of the array of nanostructures at an atomic scale.

In accordance with yet another aspect of the disclosure, a method of fabricating an electrode of a chemical system includes synthesizing an array of nanostructures on a substrate, each nanostructure of the array of nanostructures having a semiconductor composition, and depositing a catalyst arrangement along each nanostructure of the array of nanostructures, the catalyst arrangement including a metal-based catalyst for the reaction in the chemical cell. The array of nanostructures are synthesized, and the catalyst arrangement is deposited, such that the metal-based catalyst is distributed along sidewalls of each nanostructure of the array of nanostructures at an atomic scale.

In connection with any one of the aforementioned aspects, the electrodes, systems, and/or methods described herein may alternatively or additionally include or involve any combination of one or more of the following aspects or features. The catalyst arrangement includes a distribution of metal species in a discrete number of atomic layers. The discrete number of atomic layers is about three or less. The catalyst arrangement disposed along each nanostructure of the array of nanostructures includes a plurality of atomically dispersed catalysts. Adjacent nanostructures of the array of nanostructures are positioned relative to one another such that the catalyst arrangement along the sidewalls is spatially confined by the adjacent nanostructures. The metal-based catalyst includes an iron species. The metal-based catalyst includes iron oxide. The semiconductor composition of each nanostructure of the array of nanostructures includes nitrogen such that the sites are nitrogen sites. The substrate includes a semiconductor material. The semiconductor material is configured to generate charge carriers upon absorption of solar radiation such that the chemical cell is configured as a photoelectrochemical system. The semiconductor material of the substrate and the semiconductor composition of the array of nanostructures are configured such that the charge carriers generated in the substrate are extracted by the array of nanostructures. Each nanostructure of the array of nanostructures includes a respective nanowire. The semiconductor composition of each nanostructure of the array of nanostructures includes a Group III-V semiconductor material. The chemical cell is a photoelectrochemical cell. An electrochemical system includes a working electrode configured in accordance with an electrode as described herein, and further includes a counter electrode and an electrolyte in which the working and counter electrodes are immersed. The electrolyte is configured to establish a near neutral pH aqueous medium in which the working and counter electrodes are immersed. The semiconductor composition of each nanostructure of the array of nanostructures establishes sites at which the metal-based catalyst is anchored to the nanostructure. The catalyst arrangement is configured such that the metal-based catalyst is atomically dispersed at the sites. Adjacent nanostructures of the array of nanostructures are positioned relative to one another such that the catalyst arrangement along the sidewalls is spatially confined by the adjacent nanostructures. The metal-based catalyst includes an iron species, and the semiconductor composition of each nanostructure of the array of nanostructures includes a Group III-V semiconductor material. A photoelectrochemical system includes a working photocathode configured in accordance with a photocathode as described herein, and further includes a counter electrode and an electrolyte in which the working photocathode and the counter electrode are immersed. Depositing the catalyst arrangement includes implementing a number of electrodeposition cycles. The number of electrodeposition cycles is about 80 cycles.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 is a schematic view and block diagram of an electrochemical system having a working electrode with a catalyst arrangement disposed along a plurality of nanostructures for, e.g., hydrogen evolution via water splitting, in accordance with one example.

FIG. 2 is a method of fabricating an electrode with a catalyst arrangement disposed along a plurality of nanostructures for evolution of hydrogen via water splitting in accordance with one example.

FIG. 3 is a schematic view of a method of fabricating an electrode with a catalyst arrangement in which a few atomic-scale layers of an iron-based catalyst are disposed along a plurality of nanostructures for evolution of hydrogen via water splitting in accordance with one example.

FIG. 4 depicts scanning electron microscopy (SEM), low angle annular dark-field scanning transmission electron microscopy (STEM-LAADF), and other images of Fe-based catalyst arrangements on a silicon substrate and on GaN nanowires supported by a silicon substrate, along with graphical plots of spectrum data.

FIG. 5 depicts graphical plots of J-V curves, current density, and gaseous productivity for a number of catalyst arrangements, including a Fe-based, GaN nanowire-supported catalyst arrangement in accordance with one example.

FIG. 6 depicts top and perspective schematic views of atomic geometries of first, second, and third layers of iron, along with a calculated free energy diagram of a hydrogen evolution reaction for a number of catalyst arrangements, including a Fe-based, GaN nanowire-supported catalyst arrangement in accordance with one example.

FIG. 7 depicts graphical plots of differential reflectance and electrochemical impedance spectroscopy for a number of catalyst arrangements, including a Fe-based, GaN nanowire-supported catalyst arrangement in accordance with one example, along with an energy diagram for the Fe-based, GaN nanowire-supported catalyst arrangement, and a schematic illustration of the Fe-based, GaN nanowire-supported catalyst arrangement in operation for PEC water splitting towards hydrogen and oxygen in accordance with one example.

The embodiments of the disclosed electrodes, systems, and methods may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION OF THE DISCLOSURE

Electrodes of photoelectrochemical and other chemical cells having an atomic scale catalyst arrangement are described. Methods of fabricating photocathodes and other electrodes having such atomic scale catalyst arrangements are also described. In some cases, the atomic scale catalyst arrangements may be used for hydrogen evolution from water by photoelectrocatalysis. The atomic scale catalyst arrangements may involve a few atomic layers or other atomic scale distribution of a metal species, such as an iron species (e.g., iron oxide). By using iron and other metal species, the disclosed electrodes and methods may thus provide an efficient electrocatalyst for the carbon-free production of hydrogen from water splitting using earth-abundant materials.

In some cases, the catalyst arrangement may include one or more continuous atomic layers of the metal species on or along a support structure or scaffolding. In other cases, the metal species are atomically dispersed (e.g., spatially dispersed) on a surface of the support structure.

The catalyst arrangement involves an array or other plurality of nanostructures on or to which the metal species are anchored. The nanostructures thus provide the scaffolding for the catalyst species. The nanostructures may also be configured to establish an atomically dispersed distribution of the catalyst species. In some cases, a few atomic layers of iron (FeFAL), or an iron species, or other metal species, are anchored on GaN nanowire arrays (NWs). The iron-GaN nanowire catalyst arrangement is useful as a highly active hydrogen evolution reaction catalyst. The efficiency of the iron-GaN nanowire catalyst arrangement may be attributed to the spatial confinement and the nitrogen-terminated surface of the GaN nanowires. Based on density functional theoretical calculations, the hydrogen adsorption on the FeFAL:GaN nanowire arrangement is found to exhibit a significantly low free energy of −0.13 eV, indicative of intrinsically high catalytic activity. Meanwhile, its outstanding photocatalytic optoelectronic properties are realized by the strong electronic coupling between the atomic iron layers and GaN (101̅0), together with the nearly defect-free GaN nanowires. As a result, an example arrangement of FeFAL:GaN nanowires on a silicon substrate (e.g., n+/p Si) exhibited a prominent current density of about −30 mA cm⁻² at an overpotential of about 0.2 V versus reversible hydrogen electrode with a decent onset potential of +0.35 V and 98% Faradaic efficiency in 0.5 mol/L KHCO₃ aqueous solution under standard one-sun illumination. The example arrangement establishes that the disclosed electrodes, systems, and methods provide an efficient and useful atomic-level catalyst (e.g., iron-based catalyst) for converting solar energy towards hydrogen.

The disclosed electrodes and systems provide an inexpensive and convenient electrocatalyst for PEC water splitting. The catalyst arrangement of the disclosed electrodes and systems rely on iron and other earth-abundant metals for the metal species. Earth-abundant materials are also used for the scaffolding and structural support. As described herein, the low cost catalyst arrangements of the disclosed electrodes and systems are also efficient in a near neutral/alkaline aqueous medium. The inconvenience of operation in, for instance, an acidic medium, is therefore avoided.

Although described herein in connection with electrodes having GaN-based nanowire arrays with iron-based catalysts for water splitting, the disclosed electrodes are not limited to PEC-based hydrogen evolution, GaN-based nanowires, or iron-based catalyst arrangements. A wide variety of types of electrolytic or other chemical cells may benefit from use of the atomic scale catalyst arrangement, including, for instance, electrochemical cells and thermochemical cells. Thus, the disclosed electrodes, systems, and methods may also be directed to other electrolysis or other chemical reactions, including, for instance, CO₂ reduction. Various types of CO₂ reduction products may be provided, including, for instance, methane, CO, CH₃OH, CH₄, C₂H₄, C₂H₅OH, and C₂H₆. Moreover, the nature, construction, configuration, composition, shape, and other characteristics or aspects of the nanostructures on or to which the atomic scale catalysts are anchored may vary. For instance, the nanostructures may be composed of semiconductors other than GaN, such as other Group III-V nitride semiconductor materials. Furthermore, alternative or additional metal species may be used in the catalyst arrangements, including, for instance, platinum-based catalyst arrangements.

Although described herein in connection with epitaxially grown nanostructures, the nanostructures may be synthesized in other ways. For instance, the disclosed methods may synthesize the nanostructures via chemical vapor deposition, solution processing, sputtering, or laser-assisted deposition.

As used herein, the terms “atomic” and “atomic scale” are used to distinguish the catalyst arrangements of the disclosed electrodes and systems from those involving nanoparticles, nano-powders, or other objects or structures, as well as larger particles, powders, or objects, such as those at the micro-scale. Thus, for example, the terms “atomic” and “atomic scale” may refer to dimensions, spacings, gaps, features, or other aspects or characteristics of the catalyst arrangements that involve distances of less than about 1 nanometer. For example, a catalyst distributed at an atomic scale along a surface may involve or include one or more layers or other arrangements that collectively or effectively present a thickness of less than about 1 nm. In another example, a catalyst arrangement in which the catalysts are dispersed at an atomic scale, or atomically dispersed, may involve or include one or more catalyst layers or other arrangements anchored to a lattice at respective coordination sites provided at an atomic scale, rather than, for instance, catalyst atoms randomly placed about a surface. Such preferential, or site-based, anchoring of the catalysts may lead to catalysts spaced apart or otherwise distributed along the surface at an atomic scale.

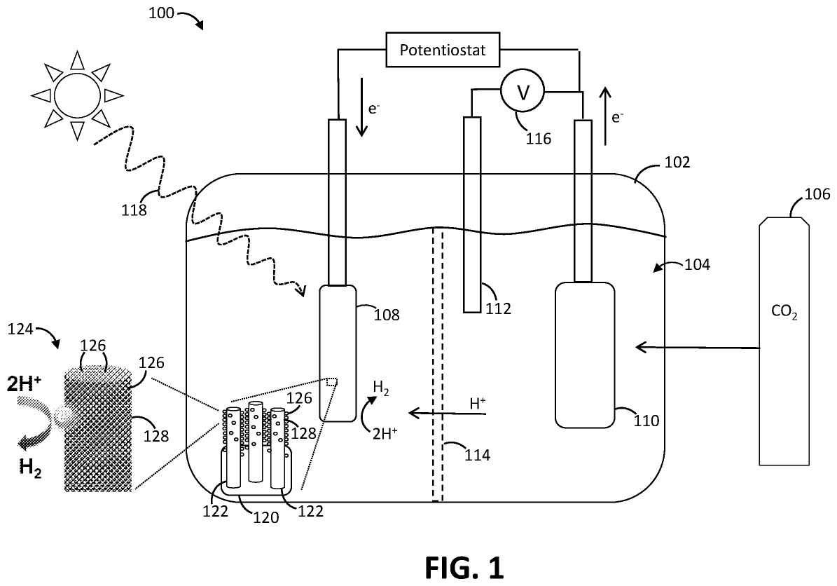

FIG. 1 depicts a system 100 for hydrogen evolution via water splitting. The system 100 may also be configured for other reactions. The system 100 may be configured as an electrochemical system. In this example, the electrochemical system 100 is a photoelectrochemical (PEC) system in which solar and/or other radiation is used to facilitate the hydrogen evolution and water splitting. The manner in which the PEC system 100 is illuminated may vary. The wavelength and other characteristics of the radiation may vary accordingly. In thermochemical examples, the source of radiation may be replaced by a heat source.

The electrochemical system 100 includes one or more electrochemical cells 102. A single electrochemical cell 102 is shown for ease in illustration and description. The electrochemical cell 102 and other components of the electrochemical system 100 are depicted schematically in FIG. 1 also for ease in illustration. The cell 102 contains an electrolyte solution 104 to which a source 106 of CO₂ is applied. In some cases, the electrolyte solution is saturated with CO₂. Potassium bicarbonate KHCO₃ may be used as an electrolyte. Additional or alternative electrolytes may be used. Further details regarding one example of the electrochemical system 100 are provided below.

The electrochemical cell 102 includes a working electrode 108, a counter electrode 110, and a reference electrode 112, each of which is immersed in the electrolyte 104. The counter electrode 110 may be or include a metal wire, such as a platinum wire. The reference electrode 112 may be configured as a reversible hydrogen electrode (RHE). The positioning of the reference electrode 112 may vary from the example shown. For example, the reference electrode 112 may be adjacent to the counter electrode 110 in other cases. The configuration of the counter and reference electrodes 110, 112 may vary. For example, the counter electrode 110 may be configured as, or otherwise include, a photoanode at which water oxidation (4H₂O⇔2O₂+8e⁻+8H⁺) occurs.

The hydrogen evolution occurs at the working electrode 112 as follows:

Hydrogen evolution: 2H⁺+2e⁻⇔H₂

To that end, electrons flow from the counter electrode 110 through a circuit path external to the electrochemical cell 102 to reach the working electrode 108. The working and counter electrodes 108, 110 may thus be considered a cathode and an anode, respectively.

In the example of FIG. 1, the working and counter electrodes are separated from one another by a membrane 114, e.g., a proton-exchange membrane. The construction, composition, configuration and other characteristics of the membrane 114 may vary.

The circuit path includes a voltage source 116 of the electrochemical system 100. The voltage source 116 is configured to apply a bias voltage between the working and counter electrodes 108, 110. The bias voltage may be used to establish a ratio of CO₂ reduction to hydrogen (H₂) evolution at the working electrode, as described further below. The circuit path may include additional or alternative components. For example, the circuit path may include a potentiometer in some cases.

In this example, the working electrode 108 is configured as a photocathode. Light 118, such as solar radiation, may be incident upon the working electrode 108 as shown. The electrochemical cell 102 may thus be considered and configured as a photoelectrochemical cell. In such cases, illumination of the working electrode 108 may cause charge carriers to be generated in the working electrode 108. Electrons that reach the surface of the working electrode 108 may then be used in the hydrogen evolution. The photogenerated electrons augment electrons provided via the current path. The photogenerated holes may move to the counter electrode for the water oxidation. Further details regarding examples of photocathodes are provided below.

The working electrode 108 includes a substrate 120. The substrate 120 of the working electrode 108 may constitute a part of an architecture, a scaffolding, or other support structure, of the working electrode 108. The substrate 120 may be uniform or composite. For example, the substrate 120 may include any number of layers or other components. The substrate 120 thus may or may not be monolithic. The shape of the substrate 120 may also vary. For instance, the substrate 120 may or may not be planar or flat.

The substrate 120 of the working electrode 108 may be active (functional) and/or passive (e.g., structural). In the latter case, the substrate 120 may be configured and act solely as a support structure for a catalyst arrangement of the working electrode 108, as described below. Alternatively or additionally, the substrate 120 may be composed of, or otherwise include, a material suitable for the growth or other deposition of the catalyst arrangement of the working electrode 108.

In active or functional cases, the substrate 120 may include a light absorbing material. The light absorbing material is configured to generate charge carriers upon solar or other illumination. The light absorbing material has a bandgap such that incident light generates charge carriers (electron-hole pairs) within the substrate. Some or all of the substrate 120 may be configured for photogeneration of electron-hole pairs. To that end, the substrate 120 may include a semiconductor material. In some cases, the substrate 120 is composed of, or otherwise includes, silicon. For instance, the substrate 120 may be provided as a silicon wafer. The silicon may be doped. In some cases, the substrate 120 is heavily n-type doped, and moderately or lightly p-type doped. The doping arrangement may vary. For example, one or more components of the substrate 120 may be non-doped (intrinsic), or effectively non-doped. The substrate 120 may include alternative or additional layers, including, for instance, support or other structural layers. In other cases, the substrate 120 is not light absorbing. In these and other cases, one or more other components of the photocathode may be configured to act as a light absorber. Thus, in photoelectrochemical cases, the semiconductor material may be configured to generate charge carriers upon absorption of solar and/or other radiation, such that the chemical cell is configured as a photoelectrochemical system.

The substrate 120 of the working electrode 108 establishes a surface at which a catalyst arrangement and catalyst support structures, or scaffolding, of the electrode 108 are provided as described below.

The working electrode 100 includes an array of nanostructures 122 supported by the substrate 120. Each nanostructure 122 is configured to extract the charge carriers (e.g., electrons) from the substrate 120. The extraction brings the electrons to external sites along the nanostructures 122 for use in the hydrogen evolution. In some cases, each nanostructure 122 is configured as a nanowire. Each nanostructure 122 may include a semiconductor core. In some cases, the core is composed of, or otherwise includes, Gallium nitride (GaN). Other semiconductor materials may be used, including, for instance, other Group III-V nitride semiconductor materials. The core of each nanowire or other nanostructure may be or include a columnar, post-shaped, or other elongated structure that extends outward (e.g., upward) from the plane of the substrate 120. The semiconductor nanowires or other nanostructures may be grown or formed as described in U.S. Pat. No. 8,563,395, the entire disclosure of which is hereby incorporated by reference. The nanostructures 122 may be referred to herein as nanowires with the understanding that the dimensions, size, shape, composition, and other characteristics of the projections 122 may vary.

Each nanostructure 122 has a semiconductor composition. The semiconductor composition may or may not be configured to act as a catalyst for the reaction(s) supported by the electrochemical system 100. For instance, each nanostructure 122 may be configured to support the catalytic conversion of carbon dioxide (CO₂) in the chemical cell 102 into, e.g., methane. As mentioned above, the semiconductor composition may include Gallium nitride. Additional or alternative semiconductor materials may be used, including, for instance, indium nitride, indium gallium nitride, aluminum nitride, boron nitride, aluminum oxide, silicon, and/or their alloys.

The nanostructures 122 may facilitate the hydrogen evolution and/or other chemical reaction in one or more ways. For instance, each conductive projection 122 may be configured to extract the charge carriers (e.g., electrons) generated in the substrate 120. The extraction brings the electrons to external sites along the nanostructures 122 for use in the hydrogen evolution and/or other chemical reaction. The composition of the nanostructures 122 may also form an interface well-suited for hydrogen evolution and/or another chemical reaction, as explained below.

Each nanostructure 122 may be or include a columnar, post-shaped, or other elongated structure that extends outward (e.g., upward) from the plane of the substrate 120. The dimensions, size, shape, composition, and other characteristics of the nanostructures 122 may vary. For instance, each nanostructure 122 may or may not be elongated like a nanowire. Thus, other types of nanostructures from the substrate 120, such as various shaped nanocrystals, may be used.

In some cases, one or more of the nanostructures 122 is configured to generate electron-hole pairs upon illumination. For instance, the nanostructures 122 may be configured to absorb light at frequencies different than other light absorbing components of the electrode 108. For example, one light absorbing component, such as the substrate 120, may be configured for absorption in the visible or infrared wavelength ranges, while another component may be configured to absorb light at ultraviolet wavelengths. In other cases, the nanostructures 122 are the only light absorbing component of the electrode 108.

The electrode 108 further includes a catalyst arrangement 124 disposed along each nanostructure 122 for hydrogen evolution and/or other electrolysis or other reaction in the chemical cell. The catalyst arrangement 124 includes a metal-based catalyst for the reaction in the chemical cell. In the example of FIG. 1, the catalyst arrangement 124 includes an atomic-scale distribution of metal species 126 disposed across each nanostructure 122. In some cases, the metal species is or includes an iron species. The iron species, or iron-based catalyst, may be composed of, or otherwise include, iron oxide.

The semiconductor composition of each nanostructure 122 establishes sites (e.g., binding sites) at which the metal-based catalyst is anchored to the nanostructure 122. For example, the semiconductor composition may include nitrogen such that the sites are nitrogen sites. In cases in which the nanostructures 122 are GaN nanowires or other nanostructures, the nitrogen sites may correspond with the nitrogen-terminated surface of the nanowire. The iron- or other metal-based catalysts may then preferentially sit at the nitrogen terminations of the GaN lattice. The anchoring sites may thus establish an atomically dispersed, or spaced apart, catalyst arrangement, as described herein.

The array of nanostructures 122 and the catalyst arrangement are configured such that the metal-based catalyst is distributed along sidewalls 128 of each nanostructure 122 at an atomic scale. For instance, adjacent nanostructures 122 of the array may be positioned relative to one another such that the catalyst arrangement along the sidewalls is spatially confined by the adjacent nanostructures 122. In some cases, the sidewalls of the adjacent nanostructures 122 may be spaced apart by a gap of about 10 nm to about 50 nm, but other gap sizes may be used. The size of the gap may lead to the atomic-scale of the catalyst arrangement along the sidewalls. Such spatial confinement may lead to a catalyst arrangement disposed along each nanostructure 122 that includes a plurality of atomically dispersed catalysts.

In some cases, the atomic scale of the catalyst arrangement is or involves a distribution of metal species in a discrete number of atomic layers. For example, the discrete number of atomic layers may be about three, although less or more layers may be present in other cases.

The first discrete atomic layer of the catalyst arrangement may be anchored to the semiconductor lattice at the aforementioned sites. The bond between the metal species and the nitrogen atoms may be an ionic-like bond. Second and subsequent layers of the catalyst arrangement may then include metallic bonds between the metal atoms in the adjacent layers. The metal species may thus remain atomically and spatially dispersed along the sidewall of the nanostructure 122 despite the multiple layers of metal species.

The atomically dispersed nature of the catalyst arrangement 124 across the nanostructures 122 may be uniform or non-uniform. For instance, the metal species may be spaced apart from one another to varying extents across the sidewalls of the nanostructures 122. Despite the lack of a continuous coating, the catalyst arrangement may nonetheless be considered to form one or more layers in the sense that the metal species may be disposed at one of a number of offsets from the sidewall of the nanostructure 122. The arrangement is depicted schematically in the drawing figures for ease in illustration, and should not be understood to convey, for instance, a continuous layer.

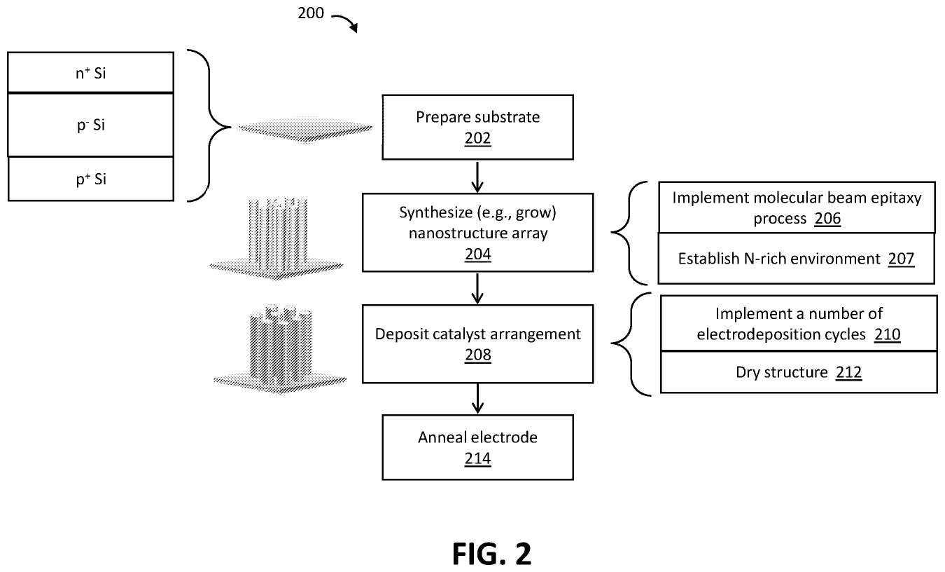

FIG. 2 depicts a method 200 of fabricating an electrode of an electrochemical system in accordance with one example. The method 200 may be used to manufacture any of the working electrodes described herein or another electrode. The method 200 may include additional, fewer, or alternative acts. For instance, the method 200 may or may not include one or more acts directed to preparing a substrate (act 202) or one or more acts directed to annealing the electrode (act 214).

The method 200 may begin with an act 202 in which a substrate is prepared. The substrate may be or be formed from a p-n Si wafer. In one example, a two-inch Si wafer may be used, but other (e.g., larger) size wafers may be used. Other semiconductors and substrates may be used, including, for instance, non-semiconductor substrates such as sapphire. Preparation of the substrate may include one or more thermal diffusion or other doping procedures. In some cases, the act 202 may include two or more doping procedures to establish an n⁺ layer or region, a p⁻ layer or region, and a p⁺ layer or region, as shown in the example of FIG. 2.

In the example of FIG. 2, the method 200 includes an act 204 in which GaN or other nanowire arrays (or other nanostructures) are grown or otherwise synthesized or formed on the substrate. The nanowire growth may be achieved in an act 206 in which plasma-assisted molecular beam epitaxy is implemented. The act 204 may be implemented under nitrogen-rich conditions in accordance with an act 207. The nitrogen-rich conditions may lead to the nitrogen-terminated surfaces (e.g., sidewalls) referred to herein. In one example, the growth conditions were as follows: a growth temperature falling in a range from about 700° C. to about 790° C. for 1.5 h, a Ga beam equivalent pressure of about 6×10⁻⁸ Torr, a nitrogen flow rate of 1 standard cubic centimeter per minute (sccm), and a plasma power of 350 W. Under such conditions, the GaN lattice may be terminated with nitrogen atoms to provide sufficient nitrogen coordination or anchoring sites. One or more of the process parameters may vary from the example provided. The nanowires provide platforms or other structures for the co-catalyst arrangement deposited in the following steps. Other platforms or structures may be formed.

In an act 208, a catalyst arrangement is deposited along each nanowire or other nanostructure of the electrode. The catalyst arrangement includes a metal-based catalyst for the reaction in the chemical cell as described herein. The act 208 may include implementation of a number of electrodeposition cycles in an act 210, after which the structure is rinsed (e.g., with distilled water) and/or dried (e.g., by dry nitrogen) in an act 212. For example, the number of cycles may be about 80, but the number may vary. The act 210 may include immersing the array of conductive projections in a solution, such as an FeCL₂ aqueous solution (e.g., 1 mmol/L, 200 mL) in iron-based cases. Each cycle of the electrodeposition process may include scanning over one or more desired potential ranges, such as from about −0.5 V to about −2.0 V (e.g., relative to an Ag/AgCl reference). After the total number of deposition cycles, a further scan may be conducted from 0.1 V to about 2.0 V. The parameters of the electrodeposition procedure, including, for instance, the scan ranges, the solution and/or precursor, and the number of cycles, may vary in accordance with the metal-based catalyst. For instance, in some cases, the number of electrodeposition cycles falls in a range from about 10 to about 100. Alternative or additional deposition procedures may be used. Further details regarding examples of the electrodeposition are provided below.

In some cases, the method 200 includes an act 214 in which the electrode is annealed. One example electrode was annealed at 400° C. for 10 min in forming gas (5% H₂, balance N₂) at a flow rate of 200 sccm. The parameters of the anneal process may vary.

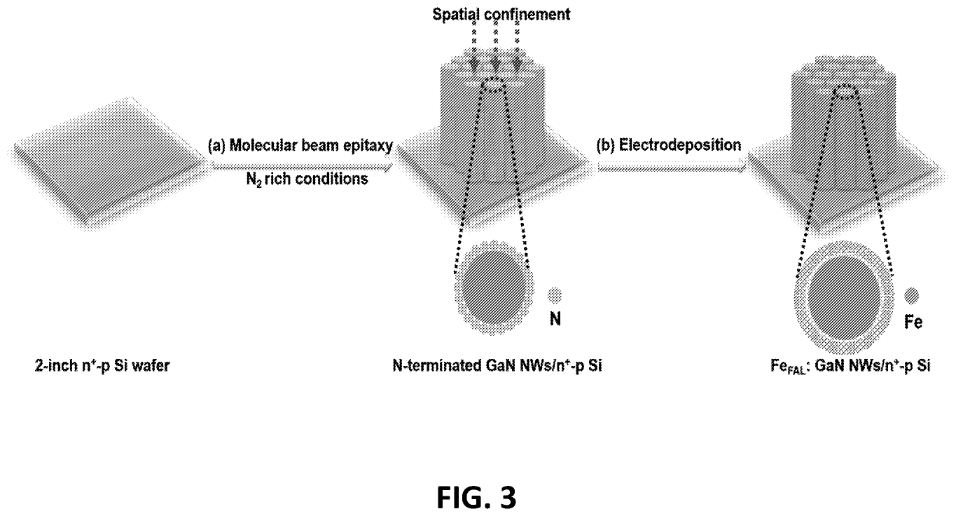

Details regarding photoelectrochemical (PEC) performance of example catalyst arrangements of the disclosed electrodes and systems are now provided in connection with FIGS. 3-7.

In these examples, the spatial confinement and N-terminated feature of GaN nanowires is used to create an atomic-scale dispersion of iron-based catalyst species anchored onto the lateral surface of GaN nanowires on a wafer-scale n+-p silicon junction. The atomic-scale dispersion of the catalyst species provides as an efficient catalyst arrangement for PEC water splitting towards hydrogen. Density functional theory (DFT) calculations are provided that suggest that few-atomic-layers iron is remarkably favorable for hydrogen evolution with an extremely low free energy of hydrogen adsorption. Moreover, strong electronic coupling between few-atomic-layers iron and GaN (101̅0), together with the well-defined GaN nanowires having a nearly defect-free structure, enable superior optoelectronic properties. Experimental results show that examples of the monolithically integrated atomic-scale catalyst/GaN nanowire/n+-p Si substrate electrode demonstrate high activity for water splitting towards hydrogen. A high photocurrent density of −15.6 mA cm⁻² is acquired at 0 V versus RHE with a decent onset potential of +0.35 V and high Faradaic efficiency of 98% in 0.5 M KHCO₃ aqueous solution at argon atmosphere under standard one-sun illumination (AM 1.5 G, 100 mW cm⁻²). A nearly saturated and high current density of about −30 mA cm⁻² is achieved at a minor overpotential of about 0.2 V. The utilization of atomic-scale iron (or other metal species) provides an inexpensive and efficient catalyst for hydrogen production in a near-neutral/alkaline aqueous medium. For instance, the aqueous medium may have a pH falling in a range from about 8 to about 10, but other media may be used in other cases (e.g. in connection with other reactions).

In the example of FIG. 3, vertically aligned GaN nanowires were grown on a 2-inch n+-p silicon wafer (GaN NWs/n+-p Si) by radio frequency plasma-assisted molecular beam epitaxy (PA-MBE). By tailoring the growth conditions, e.g., growing under N-rich conditions, the epitaxial GaN nanowire surfaces were engineered or otherwise configured to be terminated with nitrogen atoms (e.g., abundant nitrogen atoms), not only for their top c-plane, but also for the lateral nonpolar (1010) surfaces. The nitrogen (e.g., abundant nitrogen) establishes coordinating sites that provide sufficient (e.g., spaced apart) anchors for stabilizing atomically dispersed metals or metal species. The spatial confinement arising from the proximity of adjacent nanowires in the array is useful for atomically dispersed iron. As a result, atomic-scale iron (e.g., a few atomic layers of iron) was deposited onto the lateral m-plane of the GaN nanowires by an electrocatalytic process, as shown in FIG. 3. The morphology of the catalyst arrangement on the GaN nanowire/Si substrate support structure (which may be collectively referred to herein as “Feₓ:GaN NWs/n+-p Si”, with x denoting the number of deposition cycles) may be tailored by modulating the number of electrodeposition cycles. For comparison purposes, the iron cocatalyst was directly loaded on silicon through the identical process.

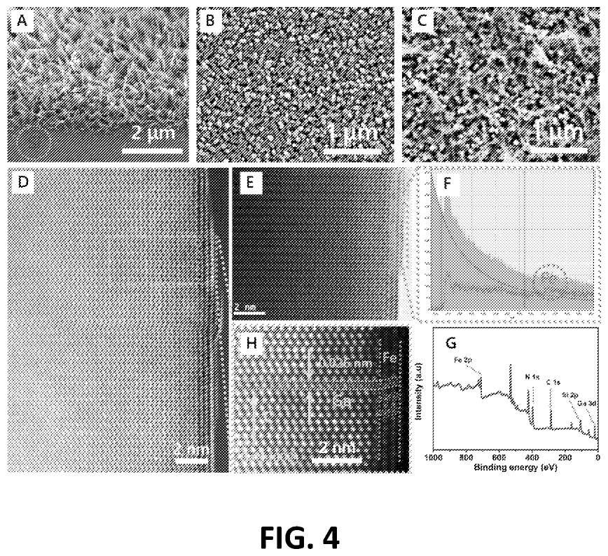

FIG. 4 depicts the structure and composition of a catalyst arrangement on GaN nanowires in accordance with one example. The catalyst arrangement on the GaN nanowires was characterized using scanning electron microscopy (SEM), scanning transmission electron microscopy (STEM), and X-ray photoelectron spectroscopy (XPS). SEM images in Part A of FIG. 4 show that, in the absence of the GaN nanowires, the iron cocatalyst on silicon substrate (Fe/n+-p Si) exhibits a nanosheet-like morphology at hundred-nanometers level owing to the lack of nitrogen coordinating sites and the lack of spatial confinement presented by adjacent nanowires. With the utilization of molecular beam epitaxy, N-terminated GaN nanowires were epitaxially grown or formed on a silicon substrate with an average length of about 300 nm and a diameter of ca. 50 nm. Moreover, as shown in the top-view SEM of GaN/n+-p Si in Part B of FIG. 4, the epitaxial GaN nanowire arrays are vertically aligned on silicon with relatively uniform spatial confinement. Such spatial confinement is essential for dispersing cocatalysts onto the lateral plane (or sidewall(s)) of the GaN nanowires at atomic level or scale. Using these nanowires as scaffolds, the iron-based cocatalyst is loaded or provided by electrodeposition, which does not significantly alter the nanowire arrays, as shown in Part C of FIG. 4. The low angle annular dark-field scanning transmission electron microscopy (STEM-LAADF) image shows that the lateral surface of GaN nanowire is covered by a few atomic layers of iron with an intimate core/shell structure or arrangement as highlighted in Part D of FIG. 4. The core has a brighter intensity, which is attributed to be Ga atoms, while the dark layer is likely to be iron atoms because the image provides Z-contrast, wherein Z is the efficient atomic number. The corresponding composition extracted summed spectrum further verifies that the outer layers are actually composed of, or including, iron species, as shown via Parts E and F of FIG. 4. High-resolution STEM images acquired from different models also corroborated the atomically dispersed iron on the lateral surface of GaN nanowires.

On the top surface of the GaN nanowires, despite a nitrogen-rich surface, iron-based cocatalysts may form nanoclusters due to the lack of spatial confinements. Based on these characterizations, both nitrogen-rich surface and spatial confinement of GaN nanowires are useful for the formation of the iron-based atomic-scale layer or dispersion.

The morphological information presented in connection with FIG. 4 is for an example fabricated with 80 cycles of iron electrodeposition (Fe₈₀:GaN NWs/n+-p Si). While the number of electrodeposition cycles may vary, the electrode fabricated with 80 cycles of iron may also be denoted as FeFAL:GaN NWs/n+-p Si herein, with “FAL” referring to the few atomic layers of a metal-based catalyst dispersed across the nanowires.

Part G of FIG. 4 depicts XPS measurement data that confirms that the iron species were successfully decorated on GaN/n+-p Si. Iron was found to exist in oxidized states, which may be due to oxidation of iron in water and air, particularly for those at nanoscale. X-ray diffraction spectroscopy characterization revealed the appearance of the feature peak of Fe₂O₃ (hematite) at 2-theta of 33.2° after the electrodeposition, while the featured peaks of GaN (002) at 2-theta of 34.5° remain intact.

The arrangement of iron catalysts offers electron sinks for effectively extracting photoinduced electrons. The iron catalyst arrangement also provides active sites for catalyzing the hydrogen evolution reaction, which is useful for achieving a high level of efficiency. In addition, high-resolution STEM-HADDF image in Part H of FIG. 4 shows that the inter-planar lattice spacing of GaN (002) is 0.26 nm, suggesting the c-axis growth direction of the nanowire. The GaN core is nearly defect-free and is capable of supporting efficient transport of the charge carriers. Moreover, the well-defined GaN nanowires are capable of maximizing the catalytic iron centers, further enhancing performance.

The PEC water splitting performance of the above-described example (FeFAL:GaN NWs/n+-p Si) as well as other working electrodes was tested using a three-electrode-configuration chamber. The working electrode was immersed in argon-purged 0.5 M KHCO₃ aqueous solution, and a solar simulator was used as the light source (AM 1.5 G, 100 mW cm⁻²). Both a platinum counter electrode and Ag/AgCl reference electrode were separated from the working electrode by Nafion membranes to exclude the possibility that platinum was redeposited onto the working electrode.

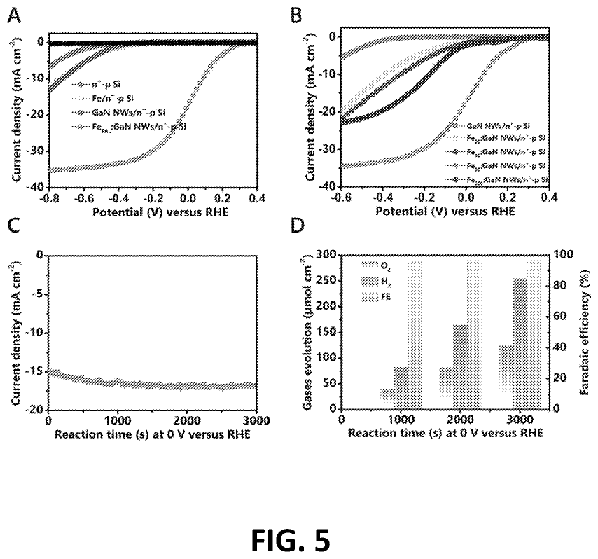

As illustrated in Part A of FIG. 5, the onset potential of bare n+-p silicon is negative, e.g., as low as −0.4 V, with a low current density of −6 mA cm⁻² at −0.8 V. The inferior performance may be attributed to ineffective incident light collection, severe charge carrier recombination, and sluggish reaction kinetics.

The incorporation of GaN nanowires reduces the strong reflection of the planar silicon substrate and facilitates electron extraction, thus improving the activity to some extent. However, due to the lack of catalytic centers, GaN nanowires on a n+-p Si substrate still suffered from limited activity.

The nanosheet-like Fe/n+-p Si showed a similar J-V curve as GaN nanowires on n+-p Si, indicating the limited activity of nanosheet-like Fe at a hundred-nanometers level.

In contrast, the FeFAL:GaN NWs/n+-p Si at 80 cycles of iron electrodeposition shows superior PEC behavior compared to that of both Fe/n+-p Si and GaN NWs/n+-p Si. The onset potential is +0.35 V versus RHE, with a prominent current density of −15.6 mA cm⁻² at 0 V versus RHE. A nearly saturated and high current density of about −30 mA cm⁻² is achieved at a minor overpotential of about 0.2 V, which is approaching the current density limit of a silicon-based photocathode under standard one-sun illumination. The highest applied bias photo-to-current efficiency (ABPE) of 0.9% is achieved at an underpotential of 0.11 V with current density of −8 mA cm⁻².

The number of the electrodeposition cycles of the Fe-based cocatalyst affected the J-V curve significantly. The increase in electrodeposition, from 20 to 40 cycles, led to a gradual improvement in PEC performance, ascribing to the increasing catalytic centers. In this example, an optimal activity was achieved at 80 cycles. However, at a higher loading, e.g., Fe₂₀₀:GaN NWs/n+-p Si, the Fe-based catalyst arrangement exhibited an evidently reduced activity with more negative onset potential and lower saturated current density, as shown in Part B of FIG. 5. The reduced activity is likely due to the low catalytic activity of a thick iron-base layer.

Based on these findings, the high hydrogen evolution reaction activity mainly arises from the atomic scale of the catalyst arrangement (e.g., a few atomic layers of iron) on the lateral surface (e.g., sidewall(s)) of the GaN nanowires, which is consistent with the results of density functional theoretical calculations described below. The activity of larger-size iron deposits is very limited.

The performance of the Fe-based catalyst arrangement was compared with a platinum-based hydrogen evolution reaction catalyst. The platinum-based catalyst had a higher positive onset potential of +0.4 V in contrast to that of +0.35 V for FeFAL:GaN NWs/n+-p Si with a relatively better fill factor due to the accelerated kinetics. Nevertheless, this result did not change the conclusion that the atomic scale of the catalyst arrangement (e.g., a few atomic layers of iron) is useful as a hydrogen evolution reaction catalyst due to its much lower price than that of noble metals like platinum.

Under dark, the current density of FeFAL:GaN NWs/n+-p Si is negligible, revealing that solar light is the energy force of the reaction. Additionally, no hydrogen was detected without the external circuit regardless of illumination, indicating that the system is a photoelectrocatalytic process.

Under example conditions, the productivity and Faradaic efficiency of FeFAL:GaN NWs/n+-p Si for hydrogen evolution reaction were evaluated at 0 V versus RHE. Under standard one-sun irradiation for 3,000 seconds, a relatively stable current density of about −16 mA cm⁻² was achieved for hydrogen evolution, as shown in Part C of FIG. 5. STEM and XPS characterizations also revealed that the morphology and chemical oxidation of the as-prepared FeFAL:GaN nanowires did not vary notably after the stability testing, suggesting the relative stability of the catalyst arrangement of the disclosed electrodes and systems.

Gas chromatography measurements indicated that the gas evolved from the working electrode was hydrogen from water reduction. The hydrogen evolution rate was as high as 306 μmol cm⁻² h⁻¹ based on the geometric surface of the photocathode with high Faradaic efficiency of 98%, as shown in Part D of FIG. 5.

At the same time, the platinum wire serving as the counter electrode produced oxygen stoichiometrically from water oxidation. A trace amount of carbon monoxide was produced with a tiny Faradaic efficiency of <1%, which might originate from the reduction of HCO³⁻ in the electrolyte. GC and H-NMR analysis suggested that no other carbon-based liquid and gaseous products were detected. These results provided direct evidence that a large proportion of the photoinduced electrons were consumed for converting protons to hydrogen with high efficiency.

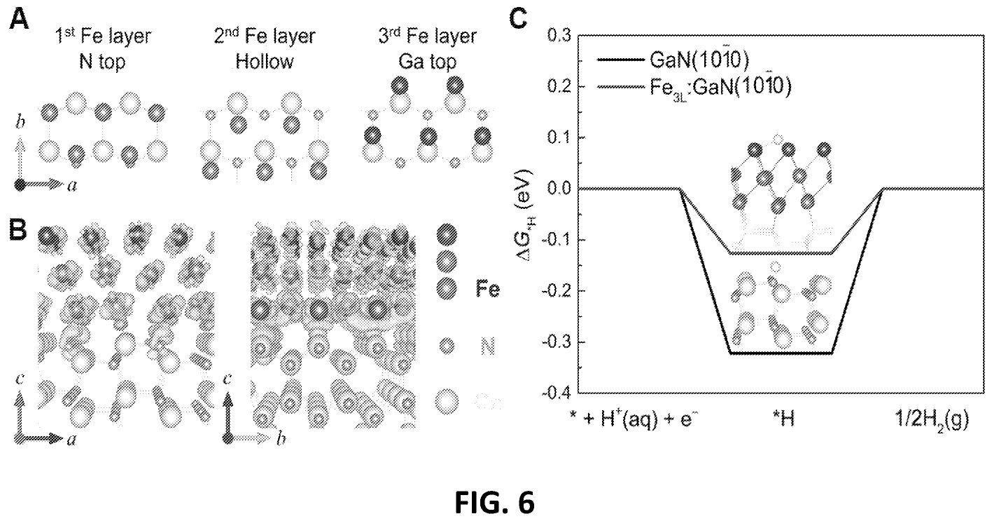

To theoretically elucidate the enhanced PEC activity of FeFAL:GaN NWs/n+-p Si at the atomic scale, density functional theory calculations were conducted to investigate the geometry and interaction between the atomic-scale Fe-based catalyst arrangement (e.g., layer) and the GaN nanowires. Based on the characterization results, a slab model containing three-layer (3L) atomic Fe on the N-terminated surface of wurtzite-GaN (101̅0) was established to study the surface and interface properties of Fe_{3L}:GaN. A top view of the optimized geometry for each layer of atomic Fe in Fe3L:GaN is presented in Part A of FIG. 6. The first layer of Fe atoms prefers to sit at the top of N atoms on the GaN (1010) surface with a Fe—N bond length of 1.98 Å, followed by the second and third layers favoring the hollow and Ga top sites, respectively. The top view of Part A of FIG. 6 separately depicts three distinct layers of atomic iron sitting in different sites. Part C of FIG. 6 is a side view depicting one hydrogen atom adsorbed (reaction intermediate of *H) on the Fe_{3L}:GaN catalyst arrangement, the solid lines between the Fe atoms represent the bonds between adjacent Fe layers. The Ga—N dimer formed from surface reconstruction on pristine GaN (101̅0) is flattened after the deposition of Fe atoms. Notably, the atomic geometry of Fe_{3L}:GaN optimized from DFT calculations is well matched with the STEM-HAADF characterization in Part D of FIG. 4, indicating the accuracy of the simulation model and method.

The electronic properties of Fe_{3L}:GaN (101̅0) were also investigated. As shown in Part B of FIG. 6, remarkable charge density redistribution is observed near the interface, suggesting a strong electronic coupling between Fe_{3L} and GaN (101̅0). Remarkable electron reduction (green color) occurs near the Fe atoms while electron accumulation (yellow color) is observed around the neighboring N atoms, which is in good consistency with the XPS observation of a minor positive shift for FeFAL:GaN NWs/n+-p Si compared to iron on a silicon substrate (Fe/n+-p Si). The first (e.g., lowest) layer of Fe atoms are thus sitting on the top of the nitrogen sites, with an ionic-like, chemical bond with the nitrogen atoms. On the other hand, with the relatively large atomic radii of the FE and Ga atoms, notable electron accumulation emerges around the middle region of the Fe and Ga atoms, which indicates the formation of covalent-like Fe—Ga bonds, even though the Fe atoms are not disposed right above the Ga atoms. These theoretical results regarding electronic properties reveal the formation of an efficient electron-transition channel that is highly favorable for the separation/migration of electron-hole pairs and for reducing the voltage loss during the reaction, which is in good agreement with the electrochemical measurements set forth herein.

In one example, FeFAL:GaN NWs/n+-p Si was applied as a photocathode for water reduction toward hydrogen while a platinum wire was used as an anode for water oxidation toward oxygen. Therefore, the theoretical calculations were focused on the free energy of hydrogen adsorption on the catalyst surface of FeFAL:GaN NWs/n+-p Si, i.e., G_{*H}, which is one metric in quantitatively assessing the hydrogen evolution reaction catalytic activity. Based on one computational hydrogen electrode (CHE) model suggested by Norskov et al. (Norskov et al., 2004), a thermo-neutral value of ΔG_{*H} (i.e., 0 eV) at which the hydrogen adsorption is neither too strong nor too weak on a catalyst surface, is useful for an ideal hydrogen evolution reaction process. Employing density functional theory calculations, the free energy diagram of the hydrogen evolution reaction for both GaN(1010) and Fe_{3L}:GaN(101̅0) were mapped out, as illustrated in Part C of FIG. 6. As shown, ΔG_{*H} shows a value of −0.32 eV on the pristine GaN(101̅0) surface, indicating a rather strong binding of hydrogen with the nitrogen atoms on the surface. Such strong binding suggests that the hydrogen evolution reaction would be unfavorable to occur on a pristine GaN surface. On the other hand, the binding strength of hydrogen on the surface of the Fe_{3L}:GaN(101̅0) is significantly weakened, resulting in very small ΔG_{*H} value of −0.13 eV, comparable to that of a state-of-the-art hydrogen evolution reaction catalyst of platinum. Additionally, to consider the possible oxidation that occurred on the surfaces, further theoretical calculations were conducted to study the effect of a partially oxidized surface of FeFAL:GaN NWs/n+-p Si on the hydrogen adsorption. It was found that the G_{*H} becomes even more thermo-neutral when the surface iron atoms are oxidized at different ratios (e.g., oxygen coverage ranging from 8% to 33%), which indicates the formation of iron oxide would further enhance the superior performance of FeFAL:GaN NWs/n+-p Si. Overall, the superior hydrogen evolution reaction performance of FeFAL:GaN NWs/n+-p Si is attributed to the synergetic effect between the strong electronic coupling at the interface region and an optimal hydrogen adsorption strength.

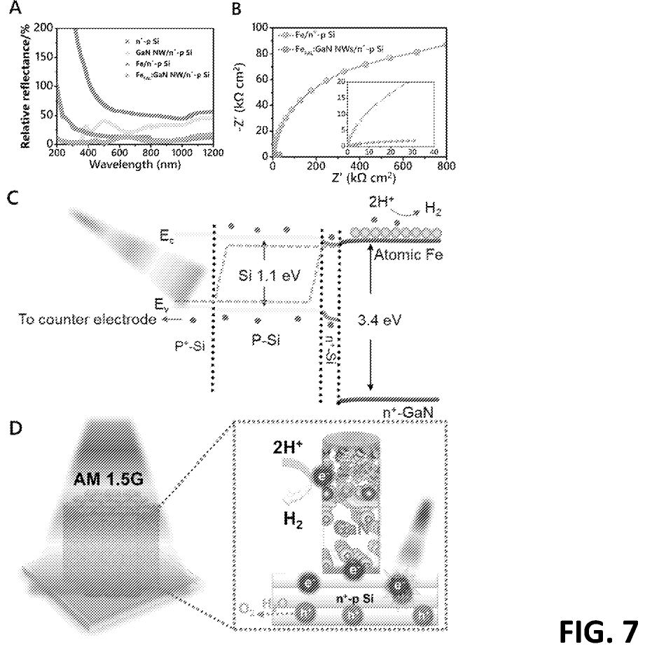

A series of optoelectronic measurements and comparisons were also made in connection with one example. In Part A of FIG. 7, ultraviolet-visible (UV-Vis) differential reflectance spectroscopy illustrates that, compared to planar silicon, GaN NWs/n+-p Si demonstrates an improved light absorption due to the light-trapping effect. The integration of iron catalyst with GaN nanowires further enhances the optical collection efficiency, rendering an excellent optical property for the reaction.

The electronic property of FeFAL:GaN NWs/n+-p Si photocathode was studied by electrochemical impedance spectroscopy. As depicted in Part B of FIG. 7, the electrochemical impedance spectroscopy shows that the radiance of FeFAL:GaN NWs/n+-p Si is much smaller than that of Fe/n+-p Si, suggesting that the electron resistance of FeFAL:GaN NWs/n+-p Si is much lower than that of the nanosheet-like Fe/n+-p Si. It reveals that the epitaxial GaN nanowires can serve as an ideal electron-transition channel for charge carrier separation, which was verified by room-temperature photoluminescence (PL) spectroscopy. Compared to GaN NWs/n+-p Si, a dramatic reduction in PL intensity of FeFAL:GaN NWs/n+-p Si suggests that the few atomic layers of Fe reduces the radiative recombination of electrons and holes.

The energy bandgap diagram of FeFAL:GaN NWs/n+-p Si is shown in Part C of FIG. 7. The conduction band alignment between GaN and Si is almost negligible. Under illumination, the upward bending of surface is reduced by the accumulated photogenerated electrons. Hence, the photoinduced electrons can be easily extracted from n+-Si to nearly dislocation-free n-GaN grown by highly controlled molecular beam epitaxy technology. The electrons further migrate to atomic Fe layers with greatly reduced voltage loss. What is more, in such a unique nanoarchitecture, the GaN nanowire is capable of maximizing catalytic centers. Together with the superior ΔG_{*H}, FeFAL:GaN NWs/n+-p Si is thus highly active for hydrogen production. Meanwhile, the holes migrate to the counter electrode via external circuit for oxygen evolution from water oxidation, as shown in Part D of FIG. 7.

In summary, in the examples described above, a few atomic layers of iron are anchored on the lateral plane (or sidewall(s)) of GaN nanostructures epitaxially grown on silicon. The anchoring is enabled by the unique abundant nitrogen coordination sites and the spatial confinement of the nanostructure arrays. Density functional theoretical calculations reveal that an impressive hydrogen adsorption free energy of −0.13 eV is achieved on the atomic iron layers, which is in favor of water splitting towards hydrogen. Moreover, the strong electronic interaction between defect-free GaN and the few atomic layers of iron can in principle provide an efficient electron-transition channel for charge carrier separation. Furthermore, the well-defined GaN nanowires render superior optical properties with high-density catalytic centers. Consequently, examples of FeFAL:GaN NWs/n+-P Si demonstrated a prominent current density of −15.6 mA c−2 at 0 V with a useful onset potential of +0.35 V in 0.5 M KHCO3 aqueous solution under standard one-sun illumination. A nearly saturated and high current density of about −30 mA cm⁻² was also achieved at a minor overpotential of about 0.2 V. The hydrogen evolution rate is as high as 306 μmol cm⁻² h⁻¹ with about 98% Faradaic efficiency.

The disclosed electrodes and systems include the two most produced semiconductors (Si and GaN) and earth-abundant material of iron as cocatalyst. The disclosed electrodes may be manufactured by mature industrial epitaxial technology and electrodeposition procedures. As such, the disclosed electrodes and systems provide a viable strategy for achieving economic, large-scale, and carbon-free hydrogen production from photoelectrochemical water splitting using solar energy.

Described above are electrodes and systems in which an inexpensive catalyst is coupled with GaN nanowires (or other nanostructures) on a n+-p silicon wafer or other substrate. The catalyst may be dispersed across the nanostructures in a few atomic layer arrangement. In some cases, the catalyst arrangement is used for hydrogen evolution from water. The disclosed electrodes and systems may be used in other photoelectrocatalysis contexts. The disclosed electrodes may be manufactured using earth-abundant materials. The disclosed electrodes and systems present a promising route for producing hydrogen and other fuels from photoelectrocatalytic reactions in an aqueous cell.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. An electrode for a reaction in a chemical cell, the electrode comprising:
a substrate having a surface;
an array of nanostructures supported by the substrate and extending outward from the surface of the substrate, each nanostructure of the array of nanostructures having a semiconductor composition; and
a catalyst arrangement disposed along each nanostructure of the array of nanostructures, the catalyst arrangement comprising a metal-based catalyst for the reaction in the chemical cell;
wherein the semiconductor composition of each nanostructure of the array of nanostructures establishes sites at which the metal-based catalyst is anchored to the nanostructure, and
wherein the array of nanostructures and the catalyst arrangement are configured such that the metal-based catalyst is distributed along sidewalls of each nanostructure of the array of nanostructures at an atomic scale.

2. The electrode of claim 1, wherein the catalyst arrangement comprises a distribution of metal species in a discrete number of atomic layers.

3. The electrode of claim 1, wherein the discrete number of atomic layers is about three or less.

4. The electrode of claim 1, wherein the catalyst arrangement disposed along each nanostructure of the array of nanostructures comprises a plurality of atomically dispersed catalysts.

5. The electrode of claim 1, wherein adjacent nanostructures of the array of nanostructures are positioned relative to one another such that the catalyst arrangement along the sidewalls is spatially confined by the adjacent nanostructures.

6. The electrode of claim 1, wherein the metal-based catalyst comprises an iron species.

7. The electrode of claim 1, wherein the metal-based catalyst comprises iron oxide.

8. The electrode of claim 1, wherein the semiconductor composition of each nanostructure of the array of nanostructures comprises nitrogen such that the sites are nitrogen sites.

9. The electrode of claim 1, wherein:
the substrate comprises a semiconductor material; and
the semiconductor material is configured to generate charge carriers upon absorption of solar radiation such that the chemical cell is configured as a photoelectrochemical system.

10. The electrode of claim 9, wherein the semiconductor material of the substrate and the semiconductor composition of the array of nanostructures are configured such that the charge carriers generated in the substrate are extracted by the array of nanostructures.

11. The electrode of claim 1, wherein each nanostructure of the array of nanostructures comprises a respective nanowire.

12. The electrode of claim 1, wherein the semiconductor composition of each nanostructure of the array of nanostructures comprises a Group III-V semiconductor material.

13. The electrode of claim 1, wherein the chemical cell is a photoelectrochemical cell.

14. An electrochemical system comprising a working electrode configured in accordance with the electrode of claim 1, and further comprising:
a counter electrode; and
an electrolyte in which the working and counter electrodes are immersed.

15. The electrochemical system of claim 13, wherein the electrolyte is configured to establish a near neutral pH aqueous medium in which the working and counter electrodes are immersed.

16. A photocathode for a reaction in a photoelectrochemical cell, the photocathode comprising:
a substrate comprising a light absorbing material, the light absorbing material being configured to generate charge carriers upon solar illumination;
an array of nanostructures supported by the substrate and extending outward from the surface of the substrate, each nanostructure of the array of nanostructures having a semiconductor composition, each nanostructure of the array of nanostructures being configured to extract the charge carriers from the substrate; and
a catalyst arrangement disposed along each nanostructure of the array of nanostructures, the catalyst arrangement comprising a metal-based catalyst for the reaction in the photoelectrochemical cell;
wherein the array of nanostructures and the catalyst arrangement are configured such that the metal-based catalyst is distributed along sidewalls of each nanostructure of the array of nanostructures at an atomic scale.

17. The photocathode of claim 16, wherein the semiconductor composition of each nanostructure of the array of nanostructures establishes sites at which the metal-based catalyst is anchored to the nanostructure.

18. The photocathode of claim 17, wherein the catalyst arrangement is configured such that the metal-based catalyst is atomically dispersed at the sites.

19. The photocathode of claim 16, wherein adjacent nanostructures of the array of nanostructures are positioned relative to one another such that the catalyst arrangement along the sidewalls is spatially confined by the adjacent nanostructures.

20. The photocathode of claim 16, wherein:
wherein the metal-based catalyst comprises an iron species; and
the semiconductor composition of each nanostructure of the array of nanostructures comprises a Group III-V semiconductor material.

21. A photoelectrochemical system comprising a working photocathode configured in accordance with the photocathode of claim 16, and further comprising:
a counter electrode; and
an electrolyte in which the working photocathode and the counter electrode are immersed.

22. A method of fabricating an electrode for a reaction in a chemical system, the method comprising:
synthesizing an array of nanostructures on a substrate, each nanostructure of the array of nanostructures having a semiconductor composition; and
depositing a catalyst arrangement along each nanostructure of the array of nanostructures, the catalyst arrangement comprising a metal-based catalyst for the reaction in the chemical cell;
wherein the array of nanostructures are synthesized, and the catalyst arrangement is deposited, such that the metal-based catalyst is distributed along sidewalls of each nanostructure of the array of nanostructures at an atomic scale.

23. The method of claim 22, wherein depositing the catalyst arrangement comprises implementing a number of electrodeposition cycles.

24. The method of claim 23, wherein the number of electrodeposition cycles is about 80 cycles.
